(19) United States
(12) Patent Application Publication
(10) Pub. No.: US 2013/0010237 A1
(43) Pub. Date: Jan. 10, 2013

(54) LIQUID CRYSTAL DISPLAY DEVICE

(76) Inventors: Natsuko FUJIYAMA, Ageo-shi (JP); Arihiro Takeda, Saitama-shi (JP)

(21) Appl. No.: 13/429,628

(22) Filed: Mar. 26, 2012

(30) Foreign Application Priority Data
Jul. 6, 2011 (JP) 2011-150149

(51) Int. Cl. G02F 1/1335; G02F 1/1343

(52) U.S. Cl. 349/103; 349/106; 349/139

(57) ABSTRACT

According to one embodiment, a liquid crystal display device includes a first substrate including a first source line and a second source line, a pixel electrode, and a first alignment film, a second substrate including an insulative substrate, a shield electrode, a black matrix, a color filter, an overcoat layer, a common electrode, and a second alignment film, and a liquid crystal layer, wherein a surface resistance of the shield electrode is higher than a surface resistance of the common electrode.

### CROSS-REFERENCE TO RELATED APPLICATIONS

This application is based upon and claims the benefit of priority from prior Japanese Patent Application No. 2011-150149, filed Jul. 6, 2011, the entire contents of which are incorporated herein by reference.

### FIELD

Embodiments described herein relate generally to a liquid crystal display device.

### BACKGROUND

In recent years, flat-panel display devices have been vigorously developed. By virtue of such advantageous features as light weight, small thickness and low power consumption, special attention has been paid to liquid crystal display devices among others. In particular, in active matrix liquid crystal devices in which switching elements are incorporated in respective pixels, attention is paid to the configuration which makes use of a lateral electric field (including a fringe electric field), such as an IPS (In-Plane Switching) mode or an FFS (Fringe Field Switching) mode. Such a liquid crystal display device of the lateral electric field mode includes pixel electrodes and a counter-electrode, which are formed on an array substrate, and liquid crystal molecules are switched by a lateral electric field which is substantially parallel to a major surface of the array substrate.

On the other hand, there has been proposed a technique wherein a lateral electric field or an oblique electric field is produced between a pixel electrode formed on an array substrate and a counter-electrode formed on a counter-substrate, thereby switching liquid crystal molecules.

### BRIEF DESCRIPTION OF THE DRAWINGS

FIG. 1 is a view which schematically illustrates a structure and an equivalent circuit of a liquid crystal display panel according to an embodiment.

FIG. 2 is a plan view which schematically shows a structure example of a pixel at a time when a liquid crystal display panel shown in FIG. 1 is viewed from a counter-substrate side.

FIG. 3 is a schematic cross-sectional view, taken along line A-A in FIG. 2, showing a cross-sectional structure of the liquid crystal display panel shown in FIG. 2.

FIG. 4 is a view for explaining an electric field which is produced between a pixel electrode and a common electrode in the liquid crystal display panel shown in FIG. 2, and a relationship between directors of liquid crystal molecules by this electric field and a transmittance.

FIG. 5 is a cross-sectional view which schematically illustrates a structure for electrically connecting a shield electrode and a common electrode.

FIG. 6 is a cross-sectional view which schematically illustrates another structure for electrically connecting the shield electrode and the common electrode.

FIG. 7 is a schematic cross-sectional view, taken along line A-A in FIG. 2, showing another cross-sectional structure of the liquid crystal display panel shown in FIG. 2.

FIG. 8 is a schematic cross-sectional view, taken along line A-A in FIG. 2, showing another cross-sectional structure of the liquid crystal display panel shown in FIG. 2.

FIG. 9 is a schematic cross-sectional view, taken along line A-A in FIG. 2, showing another cross-sectional structure of the liquid crystal display panel shown in FIG. 2.

FIG. 10 is a plan view which schematically shows another structure example of the pixel at a time when the liquid crystal display panel shown in FIG. 1 is viewed from the counter-substrate side.

FIG. 11 is a plan view which schematically shows another structure example of the pixel at a time when the liquid crystal display panel shown in FIG. 1 is viewed from the counter-substrate side.

FIG. 12 is a plan view which schematically shows another structure example of the pixel at a time when the liquid crystal display panel shown in FIG. 1 is viewed from the counter-substrate side.

### DETAILED DESCRIPTION

In general, according to one embodiment, a liquid crystal display device includes a first substrate including a first source line and a second source line which are disposed with a distance in a first direction and extend in a second direction crossing the first direction, a pixel electrode located between the first source line and the second source line and including a strip-shaped main pixel electrode linearly extending in the second direction, and a first alignment film which covers the pixel electrode, is formed of a material exhibiting horizontal alignment properties and is subjected to alignment treatment in a first alignment treatment direction; a second substrate including an insulative substrate, a shield electrode disposed over an entirety of an inner surface of the insulative substrate, which is opposed to the first substrate, a black matrix formed on that side of the shield electrode, which is opposed to the first substrate, and forming an aperture portion opposed to the pixel electrode, a color filter which covers the shield electrode in the aperture portion and extends over the black matrix, an overcoat layer covering the color filter, a common electrode formed on that side of the overcoat layer, which is opposed to the first substrate, and including main common electrodes extending in the second direction on both sides of the main pixel electrode, and a second alignment film which covers the common electrode, is formed of a material exhibiting horizontal alignment properties and is subjected to alignment treatment in a second alignment treatment direction which is parallel to the first alignment treatment direction; and a liquid crystal layer including liquid crystal molecules held between the first substrate and the second substrate, wherein a surface resistance of the shield electrode is higher than a surface resistance of the common electrode.

According to another embodiment, a liquid crystal display device includes a first substrate including a first source line and a second source line which are disposed with a distance in a first direction and extend in a second direction crossing the first direction, a pixel electrode located between the first source line and the second source line and including a strip-shaped main pixel electrode linearly extending in the second direction, and a first alignment film which covers the pixel electrode, is formed of a material exhibiting horizontal alignment properties and is subjected to alignment treatment in a first alignment treatment direction; a second substrate including an insulative substrate, a black matrix disposed on an inner surface of the insulative substrate, which is opposed to the first substrate, and forming an aperture portion opposed to the pixel electrode, a shield electrode disposed in that part of the inner surface of the insulative substrate, which is located in the aperture portion, a color filter which covers the shield electrode and extends over the black matrix, an overcoat layer covering the color filter, a common electrode formed on that side of the overcoat layer, which is opposed to the first substrate, and including main common electrodes extending in the second direction on both sides of the main pixel electrode, and a second alignment film which covers the common electrode, is formed of a material exhibiting horizontal alignment properties and is subjected to alignment treatment in a second alignment treatment direction which is parallel to the first alignment treatment direction; and a liquid crystal layer including liquid crystal molecules held between the first substrate and the second substrate, wherein a surface resistance of the shield electrode is higher than a surface resistance of the common electrode.

According to another embodiment, a liquid crystal display device includes a first substrate including a first source line and a second source line which extend substantially in parallel to each other, and a pixel electrode including a main pixel electrode linearly extending between the first source line and the second source line; a second substrate including an insulative substrate, a shield electrode disposed on an inner surface of the insulative substrate, which is opposed to the first substrate, and a common electrode including main common electrodes which are opposed to the first source line and the second source line, respectively, and extend substantially in parallel to the main pixel electrode; and a liquid crystal layer including liquid crystal molecules held between the first substrate and the second substrate, wherein a surface resistance of the shield electrode is higher than a surface resistance of the common electrode.

Embodiments will now be described in detail with reference to the accompanying drawings. In the drawings, structural elements having the same or similar functions are denoted by like reference numerals, and an overlapping description is omitted.

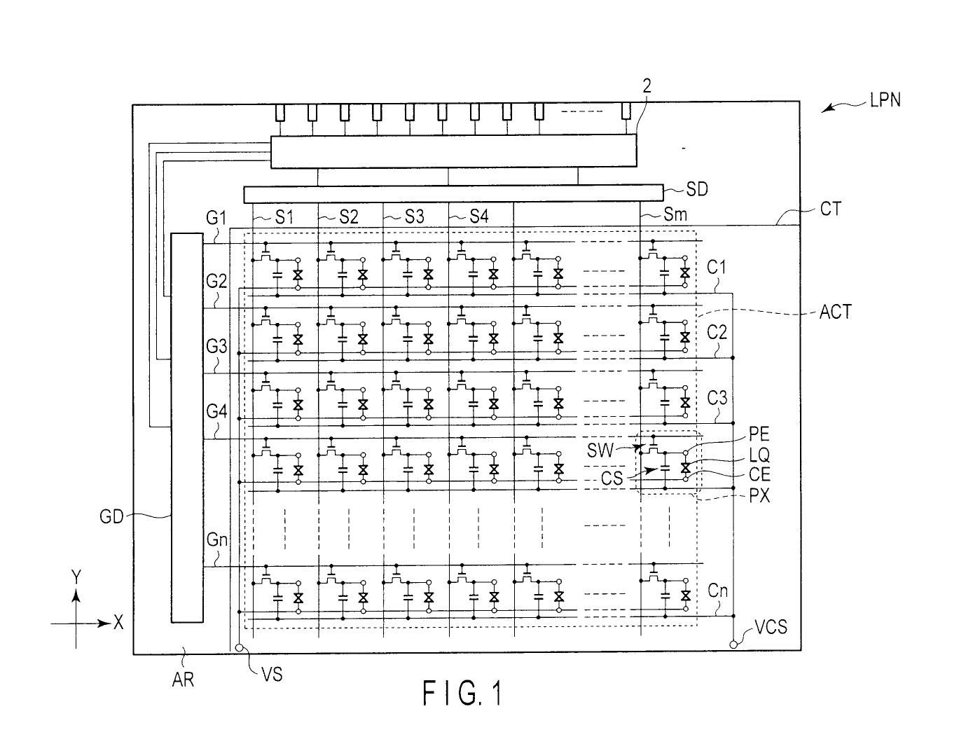

FIG. 1 is a view which schematically shows a structure and an equivalent circuit of a liquid crystal display device according to an embodiment.

Specifically, the liquid crystal display device includes an active-matrix-type liquid crystal display panel LPN. The liquid crystal display panel LPN includes an array substrate AR which is a first substrate, a counter-substrate CT which is a second substrate that is disposed to be opposed to the array substrate AR, and a liquid crystal layer LQ which is disposed between the array substrate AR and the counter-substrate CT. The liquid crystal display panel LPN includes an active area ACT which displays an image. The active area ACT is composed of a plurality of pixels PX which are arrayed in a matrix of m×n (m and n are positive integers).

The liquid crystal display panel LPN includes, in the active area ACT, an n-number of gate lines G (G1 to Gn), an n-number of storage capacitance lines C (C1 to Cn), and an m-number of source lines S (S1 to Sm). The gate lines G and storage capacitance lines C extend in a first direction X. The gate lines G and storage capacitance lines C neighbor at intervals along a second direction Y crossing the first direction X, and are alternately arranged in parallel. In this example, the first direction X and the second direction Y are perpendicular to each other. The source lines S cross the gate lines G and storage capacitance lines C. The source lines S extend substantially linearly along the second direction Y. It is not always necessary that each of the gate lines G, storage capacitance lines C and source lines S extend linearly, and a part thereof may be bent.

Each of the gate lines G is led out to the outside of the active area ACT and is connected to a gate driver GD. Each of the source lines S is led out to the outside of the active area ACT and is connected to a source driver SD. At least parts of the gate driver GD and source driver SD are formed on, for example, the array substrate AR, and are connected to a driving IC chip 2 which incorporates a controller.

Each of the pixels PX includes a switching element SW, a pixel electrode PE and a common electrode CE. A storage capacitance CS is formed, for example, between the storage capacitance line C and the pixel electrode PE. The storage capacitance line C is electrically connected to a voltage application module VCS to which a storage capacitance voltage is applied.

In the present embodiment, the liquid crystal display panel LPN is configured such that the pixel electrodes PE are formed on the array substrate AR, and at least a part of the common electrode CE is formed on the counter-substrate CT, and liquid crystal molecules of the liquid crystal layer LQ are switched by mainly using an electric field which is produced between the pixel electrodes PE and the common electrode CE. The electric field, which is produced between the pixel electrodes PE and the common electrode CE, is an oblique electric field which is slightly inclined to an X-Y plane which is defined by the first direction X and second direction Y, or to a substrate major surface of the array substrate AR or a substrate major surface of the counter-substrate CT (or a lateral electric field which is substantially parallel to the substrate major surface).

The switching element SW is composed of, for example, an n-channel thin-film transistor (TFT). The switching element SW is electrically connected to the gate line G and source line S. The switching element SW may be of a top gate type or a bottom gate type. In addition, a semiconductor layer of the switching element SW is formed of, for example, polysilicon, but it may be formed of amorphous silicon.

The pixel electrodes PE are disposed in the respective pixels PX, and are electrically connected to the switching elements SW. The common electrode CE has, for example, a common potential, and is disposed common to the pixel electrodes PE of plural pixels PX via the liquid crystal layer LQ. The pixel electrodes PE and common electrode CE are formed of a light-transmissive, electrically conductive material such as indium tin oxide (ITO) or indium zinc oxide (IZO). However, the pixel electrodes PE and common electrode CE may be formed of other metallic material such as aluminum.

The array substrate AR includes a power supply module VS for applying a voltage to the common electrode CE. The power supply module VS is formed, for example, on the outside of the active area ACT. The common electrode CE is led out to the outside of the active area ACT, and is electrically connected to the power supply module VS via an electrically conductive member (not shown).

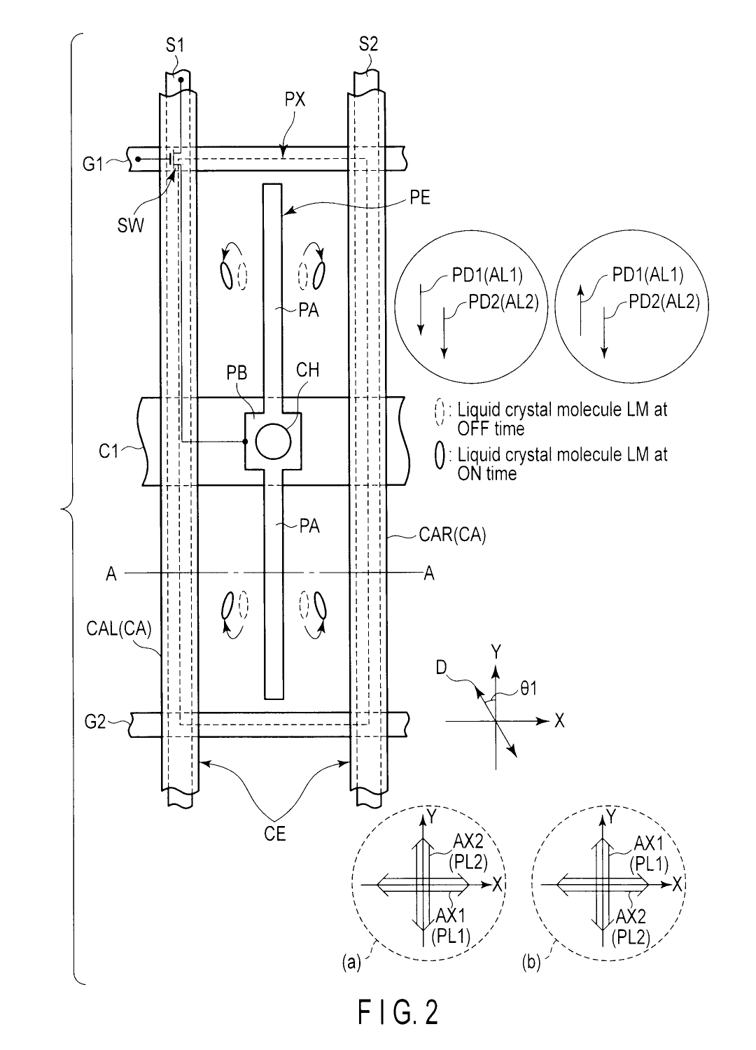

FIG. 2 is a plan view which schematically shows a structure example of one pixel PX at a time when the liquid crystal display panel LPN shown in FIG. 1 is viewed from the counter-substrate side. FIG. 2 is a plan view in an X-Y plane.

A gate line G1, a gate line G2 and a storage capacitance line C1 extend in the first direction X. A source line S1 and a source line S2 extend in the second direction Y. The storage capacitance line C1 is located at a substantially middle point between the gate line G1 and the gate line G2. Specifically, the distance between the gate line G1 and the storage capacitance line C1 in the second direction Y is substantially equal to the distance between the gate line G2 and the storage capacitance line C1 in the second direction Y.

In the example illustrated, the pixel PX corresponds to a grid region which is formed by the gate line G1, gate line G2, source line S1 and source line S2, as indicated by a broken line in FIG. 2. The pixel PX has a rectangular shape having a greater length in the second direction Y than in the first direction X. The length of the pixel PX in the first direction X corresponds to a pitch between the source line S1 and source line S2 in the first direction X. The length of the pixel PX in the second direction Y corresponds to a pitch between the gate line G1 and gate line G2 in the second direction Y. The pixel electrode PE is disposed between the source line S1 and source line S2 which neighbor each other. In addition, the pixel electrode PE is located between the gate line G1 and gate line G2.

In the example illustrated, in the pixel PX, the source line S1 is disposed at a left side end portion, the source line S2 is disposed at a right side end portion, the gate line G1 is disposed at an upper side end portion, and the gate line G2 is disposed at a lower side end portion. Strictly speaking, the source line S1 is disposed to extend over a boundary between the pixel PX and a pixel neighboring on the left side, the source line S2 is disposed to extend over a boundary between the pixel PX and a pixel neighboring on the right side, the gate line G1 is disposed to extend over a boundary between the pixel PX and a pixel neighboring on the upper side, and the gate line G2 is disposed to extend over a boundary between the pixel PX and a pixel neighboring on the lower side. The storage capacitance line C1 is disposed at a substantially central part of the pixel PX.

The switching element SW in the illustrated example is electrically connected to the gate line G1 and source line S1. The switching element SW is provided at an intersection between the gate line G1 and source line S1. A drain line of the switching element SW is formed to extend along the source line S1 and storage capacitance line C1, and is electrically connected to the pixel electrode PE via a contact hole CH which is formed at an area overlapping the storage capacitance line C1. The switching element SW is provided in an area overlapping the source line S1 and storage capacitance line C1, and does not substantially protrude from the area overlapping the source line S1 and storage capacitance line C1, thus suppressing a decrease in area of an aperture portion which contributes to display.

The pixel electrode PE includes a main pixel electrode PA and a sub-pixel electrode PB. The main pixel electrode PA and sub-pixel electrode PB are formed to be integral or continuous, and are electrically connected to each other. In the meantime, in the example illustrated, only the pixel electrode PE which is disposed in one pixel PX is shown, but pixel electrodes of the same shape are disposed in other pixels, the depiction of which is omitted.

The main pixel electrode PA linearly extends in the second direction Y from the sub-pixel electrode PB to the vicinity of the upper side end portion of the pixel PX and to the vicinity of the lower side end portion of the pixel PX. The main pixel electrode PA is formed in a strip shape having a substantially equal width in the first direction X. The sub-pixel electrode PB linearly extends in the first direction X from the main pixel electrode PA towards the source line S1 and source line S2. The sub-pixel electrode PB is formed in a strip shape having a substantially equal width in the second direction Y and, in the example illustrated, the sub-pixel electrode PB is formed to have a greater width than the main pixel electrode PA. In addition, the sub-pixel electrode PB is located in an area overlapping the storage capacitance line C1, and is electrically connected to the switching element SW via a contact hole CH.

The main pixel electrode PA is located at a substantially middle position between the source line S1 and source line S2, that is, at a center of the pixel PX. The distance in the first direction X between the source line S1 and the main pixel electrode PA is substantially equal to the distance in the first direction X between the source line S2 and the main pixel electrode PA.

The common electrode CE includes main common electrodes CA. The main common electrodes CA extend, in the X-Y plane, linearly in the second direction Y that is substantially parallel to the main pixel electrode PA, on both sides of the main pixel electrode PA. Alternatively, the main common electrodes CA are opposed to the source lines S, and extend substantially in parallel to the main pixel electrode PA. The main common electrode CA is formed in a strip shape having a substantially equal width in the first direction X.

In the example illustrated, two main common electrodes CA are arranged in parallel with a distance in the first direction X, and are disposed at both the left and right end portions of the pixel PX. In the description below, in order to distinguish these main common electrodes CA, the main common electrode on the left side in FIG. 2 is referred to as “CAL”, and the main common electrode on the right side in FIG. 2 is referred to as “CAR”. The main common electrode CAL is opposed to the source line S1, and the main common electrode CAR is opposed to the source line S2. The main common electrode CAL and the main common electrode CAR are electrically connected to each other within the active area or outside the active area.

In the pixel PX, the main common electrode CAL is disposed at the left side end portion, and the main common electrode CAR is disposed at the right side end portion. Strictly speaking, the main common electrode CAL is disposed to extend over a boundary between the pixel PX and a pixel neighboring on the left side, and the main common electrode CAR is disposed to extend over a boundary between the pixel PX and a pixel neighboring on the right side.

Paying attention to the positional relationship between the pixel electrode PE and the main common electrodes CA, the pixel electrode PE and the main common electrodes CA are alternately arranged along the first direction X. The main pixel electrode PA and the main common electrodes CA are disposed in parallel to each other. In this case, in the X-Y plane, each of the main common electrodes CA does not overlap the pixel electrode PE.

One pixel electrode PE is located between the main common electrode CAL and main common electrode CAR which neighbor each other. In other words, the main common electrode CAL and main common electrode CAR are disposed on both sides of a position immediately above the pixel electrode PE. Alternatively, the pixel electrode PE is disposed between the main common electrode CAL and main common electrode CAR. Thus, the main common electrode CAL, main pixel electrode PA and main common electrode CAR are arranged in the named order along the first direction X.

The distance between the pixel electrode PE and the common electrode CE is substantially uniform along the first direction X. The main pixel electrode PA is located at a substantially middle point between the main common electrode CAL and main common electrode CAR. Specifically, the distance between the main common electrode CAL and the main pixel electrode PA in the first direction X is substantially equal to the distance between the main common electrode CAR and the main pixel electrode PA in the first direction X.

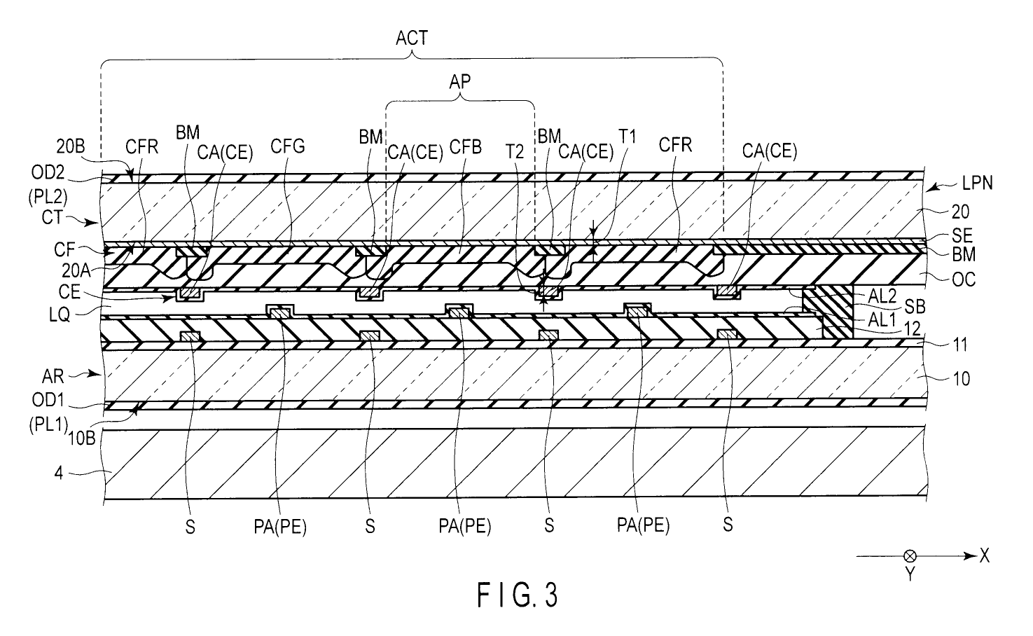

FIG. 3 is a schematic cross-sectional view, taken along line A-A in FIG. 2, showing a cross-sectional structure of the liquid crystal display panel LPN shown in FIG. 2. FIG. 3 shows only parts which are necessary for the description.

A backlight 4 is disposed on the back side of the array substrate AR which constitutes the liquid crystal display panel LPN. Various modes are applicable to the backlight 4. As the backlight 4, use may be made of either a backlight which utilizes a light-emitting diode (LED) as a light source, or a backlight which utilizes a cold cathode fluorescent lamp (CCFL) as a light source. A description of the detailed structure of the backlight 4 is omitted.

The array substrate AR is formed by using a first insulative substrate 10 having light transmissivity. Source lines S are formed on a first interlayer insulation film 11, and are covered with a second interlayer insulation film 12. Gate lines and storage capacitance lines, which are not shown, are disposed, for example, between the first insulative substrate 10 and the first interlayer insulation film 11. Pixel electrodes PE are formed on the second interlayer insulation film 12. Each pixel electrode PE is located on the inside of a position immediately above each of neighboring source lines S. A first alignment film AL1 is disposed on that surface of the array substrate AR, which is opposed to the counter-substrate CT, and the first alignment film AL1 extends over substantially the entirety of the active area ACT. The first alignment film AL1 covers the pixel electrode PE, etc., and is also disposed over the second interlayer insulation film 12. The first alignment film AL1 is formed of a material which exhibits horizontal alignment properties. In the meantime, the array substrate AR may include a part of the common electrode CE.

The counter-substrate CT is formed by using a second insulative substrate 20 having light transmissivity. The counter-substrate CT includes a shield electrode SE, a black matrix BM, a color filter CF, an overcoat layer OC, a common electrode CE, and a second alignment film AL2.

The shield electrode SE is disposed on an inner surface 20A of the second insulative substrate 20, which is opposed to the array substrate AR. In the example illustrated, the shield electrode SE is disposed over the entirety of the inner surface 20A of the second insulative substrate 20, and extends over not only the active area ACT but also the peripheral area thereof. In addition, the shield electrode SE has a relatively small film thickness T1. The shield electrode SE is formed of a light-transmissive, electrically conductive material such as ITO or IZO.

In the counter-substrate CT, the shield electrode SE and the common electrode CE are disposed in different layers. The distance between the main common electrodes CA in the first direction X of the pixel PX is greater than the thickness (cell gap) of the liquid crystal layer LQ. In addition, the shield electrode SE is also disposed between the main common electrodes CA.

Accordingly, in the structure illustrated, the ratio of the area occupied by the shield electrode SE in one pixel is greater than the ratio of the area occupied by the common electrode CE.

The shield electrode SE suppresses the entrance of an undesired electric field from the outside to the liquid crystal layer LQ. Thus, even in the case where the thickness T1 of the shield electrode SE is relatively small or the surface resistance of the shield electrode SE is relatively high, if the shield electrode SE has electrical conductivity, an electric charge can be dispersed within the surface of the shield electrode SE, and the electric field shield effect can be exhibited. Conversely, in the case where the thickness T1 of the shield electrode SE is thick or the surface resistance of the shield electrode SE is relatively low, this is undesirable since there is concern that an adverse effect is exerted on an electric field which is to be normally applied to the liquid crystal layer LQ (i.e. an electric field which is produced between the pixel electrode PE and the common electrode CE).

In the case of the above-described structure, compared to the structure in which the ratio of the area occupied by the shield electrode SE in one pixel is smaller than the ratio of the area occupied by the common electrode CE, a greater effect is exerted on the liquid crystal layer LQ by an electric field which is produced from the shield electrode SE. Hence, in the case where the surface resistance of the shield electrode SE is equal to or lower than the surface resistance of the common electrode CE, there is concern that the electric field from the shield electrode SE affects the liquid crystal layer LQ and disturbs the alignment of liquid crystal molecules. Therefore, taking into account the effect of the electric field by the shield electrode SE on the liquid crystal layer LQ, it is desirable that the surface resistance (Ω/□) of the shield electrode SE be higher than the surface resistance (Ω/□) of the common electrode CE.

The black matrix BM partitions the pixels PX and forms aperture portions AP which are opposed to the pixel electrodes PE. Specifically, the black matrix BM is disposed so as to be opposed to wiring portions, such as the source lines S, gate lines, storage capacitance lines, and switching elements. In this example, only those portions of the black matrix BM, which extend in the second direction Y, are depicted, but the black matrix BM may include portions extending in the first direction X. The black matrix BM is disposed on that side of the shield electrode SE, which is opposed to the array substrate AR. The field electrode SE, which is located in the aperture portion AP, is exposed from the black matrix BM.

The color filter CF is disposed in association with each pixel PX. Specifically, the color filter CF covers the shield electrode SE which is located in the aperture portion AP, and a part of the color filter CF extends over the black matrix BM. Color filters CF, which are disposed in the pixels PX neighboring in the first direction X, have mutually different colors. For example, the color filters CF are formed of resin materials which are colored in three primary colors of red, blue and green. A red color filter CFR, which is formed of a resin material that is colored in red, is disposed in association with a red pixel. A blue color filter CFB, which is formed of a resin material that is colored in blue, is disposed in association with a blue pixel. A green color filter CFG, which is formed of a resin material that is colored in green, is disposed in association with a green pixel. Boundaries between these color filters CF are located at positions overlapping the black matrix BM. The overcoat layer OC covers the color filters CF. The overcoat layer OC reduces the effect of asperities on the surface of the color filters CF. The overcoat layer OC is formed of, for example, a transparent resin material.

The common electrode CE is formed on that side of the overcoat layer OC, which is opposed to the array substrate AR. The common electrode CE (main common electrode CA) has a relatively large film thickness T2. It is desirable that the common electrode CE have a low resistance since an in-plane voltage drop (voltage gradient) needs to be reduced in order to apply a substantially uniform voltage to the respective pixels PX in the active area ACT.

As described above, in the counter-substrate CT, the shield electrode SE and common electrode CE, which are disposed in the active area ACT, have different roles. The film thickness T1 of the shield electrode SE is smaller than the film thickness T2 of the common electrode CE. Alternatively, the shield electrode CE has a higher resistance than the common electrode CE.

In the illustrated cross section, the main common electrode CA is located under the black matrix BM, and is located above the source line S. The black matrix BM and main common electrode CA are located immediately above the source line S. The main common electrode CA has a width which is equal to or less than the width of the opposed black matrix BM. The shield electrode SE covers not only the region above the pixel electrode PE, but also the region between the pixel electrode PE and the source line S (i.e. the region between the pixel electrode PE and the common electrode CE). The black matrix BM extending in the second direction Y, like the main common electrode CA, the color filter CF extending over the black matrix BM, and the overcoat layer OC covering the color filter CF, are disposed as dielectric layers between the shield electrode SE and the main common electrode CA.

The second alignment film AL2 is disposed on that surface of the counter-substrate CT, which is opposed to the array substrate AR, and the second alignment film AL2 extends over substantially the entirety of the active area ACT. The second alignment film AL2 covers the common electrodes CE and overcoat layer OC. The second alignment film AL2 is formed of a material which exhibits horizontal alignment properties.

The first alignment film AL1 and second alignment film AL2 are subjected to alignment treatment (e.g. rubbing treatment or optical alignment treatment) for initially aligning the liquid crystal molecules of the liquid crystal layer LQ. A first alignment treatment direction PD1, in which the first alignment film AL1 initially aligns the liquid crystal molecules, is parallel to a second alignment treatment direction PD2, in which the second alignment film AL2 initially aligns the liquid crystal molecules. In an example shown in part (A) of FIG. 2, the first alignment treatment direction PD1 and second alignment treatment direction PD2 are parallel to each other and are identical. In an example shown in part (B) of FIG. 2, the first alignment treatment direction PD1 and second alignment treatment direction PD2 are parallel to each other and are opposite to each other.

The above-described array substrate AR and counter-substrate CT are disposed such that their first alignment film AL1 and second alignment film AL2 are opposed to each other. In this case, columnar spacers, which are formed of, e.g. a resin material so as to be integral to one of the array substrate AR and counter-substrate CT, are disposed between the first alignment film AL1 of the array substrate AR and the second alignment film AL2 of the counter-substrate CT. Thereby, a predetermined cell gap, for example, a cell gap of 2 to 7 μm, is created. The array substrate AR and counter-substrate CT are attached by a sealant SB on the outside of the active area ACT in the state in which the predetermined cell gap is created therebetween.

The liquid crystal layer LQ is held in the cell gap which is created between the array substrate AR and the counter-substrate CT, and is disposed between the first alignment film AL1 and second alignment film AL2. The liquid crystal layer LQ includes liquid crystal molecules LM. The liquid crystal layer LQ is composed of a liquid crystal material having a positive (positive-type) dielectric constant anisotropy.

A first optical element OD1 is attached, by, e.g. an adhesive, to an outer surface 10B of the first insulative substrate 10 which constitutes the array substrate AR. The first optical element OD1 is located on that side of the liquid crystal display panel LPN, which is opposed to the backlight 4, and controls the polarization state of incident light which enters the liquid crystal display panel LPN from the backlight 4. The first optical element OD1 includes a first polarizer PL1 having a first polarization axis (or first absorption axis) AX1. In the meantime, another optical element, such as a retardation plate, may be disposed between the first polarizer PL1 and the first insulative substrate 10.

A second optical element OD2 is attached, by, e.g. an adhesive, to an outer surface 20B of the second insulative substrate 20 which constitutes the counter-substrate CT. The second optical element OD2 is located on the display surface side of the liquid crystal display panel LPN, and controls the polarization state of emission light emerging from the liquid crystal display panel LPN. The second optical element OD2 includes a second polarizer PL2 having a second polarization axis (or second absorption axis) AX2. In the meantime, another optical element, such as a retardation plate, may be disposed between the second polarizer PL2 and the second insulative substrate 20.

The first polarization axis AX1 of the first polarizer PL1 and the second polarization axis AX2 of the second polarizer PL2 have a positional relationship of crossed Nicols. In this case, one of the polarizers is disposed such that the polarization axis thereof is parallel or perpendicular to an initial alignment direction of liquid crystal molecules LM, that is, the first alignment treatment direction PD1 or second alignment treatment direction PD2. When the initial alignment direction is parallel to the second direction Y, the polarization axis of one polarizer is parallel to the second direction Y or is parallel to the first direction X.

In an example shown in part (a) of FIG. 2, the first polarizer PL1 is disposed such that the first polarization axis AX1 thereof is perpendicular to the second direction Y that is the initial alignment direction of liquid crystal molecules LM, and the second polarizer PL2 is disposed such that the second polarization axis AX2 thereof is parallel to the initial alignment direction of liquid crystal molecules LM. In addition, in an example shown in part (b) of FIG. 2, the second polarizer PL2 is disposed such that the second polarization axis AX2 thereof is perpendicular to the second direction Y that is the initial alignment direction of liquid crystal molecules LM, and the first polarizer PL1 is disposed such that the first polarization axis AX1 thereof is parallel to the initial alignment direction of liquid crystal molecules LM.

Next, the operation of the liquid crystal display panel LPN having the above-described structure is described with reference to FIG. 2 and FIG. 3.

Specifically, in a state in which no voltage is applied to the liquid crystal layer LQ, that is, in a state (OFF time) in which no electric field is produced between the pixel electrode PE and common electrode CE, the liquid crystal molecule LM of the liquid crystal layer LQ is aligned such that the major axis thereof is positioned in the first alignment treatment direction PD1 of the first alignment film AL1 and the second alignment treatment direction PD2 of the second alignment film AL2. This OFF time corresponds to the initial alignment state, and the alignment direction of the liquid crystal molecule LM at the OFF time corresponds to the initial alignment direction.

Strictly speaking, the liquid crystal molecule LM is not always aligned in parallel to the X-Y plane, and, in many cases, the liquid crystal molecule LM is pre-tilted. Thus, the initial alignment direction of the liquid crystal molecule LM corresponds to a direction in which the major axis of the liquid crystal molecule LM at the OFF time is orthogonally projected onto the X-Y plane. In the description below, for the purpose of simplicity, it is assumed that the liquid crystal molecule LM is aligned in parallel to the X-Y plane, and the liquid crystal molecule LM rotates in a plane parallel to the X-Y plane.

In this case, each of the first alignment treatment direction PD1 and the second alignment treatment direction PD2 is substantially parallel to the second direction Y. At the OFF time, the liquid crystal molecule LM is initially aligned such that the major axis thereof is substantially parallel to the second direction Y, as indicated by a broken line in FIG. 2. Specifically, the initial alignment direction of the liquid crystal molecule LM is parallel to the second direction Y (or 0° to the second direction Y).

When the first alignment treatment direction PD1 and the second alignment treatment direction PD2 are parallel and identical to each other, as in the example illustrated, the liquid crystal molecules LM are substantially horizontally aligned (the pre-tilt angle is substantially zero) in the middle part of the liquid crystal layer LQ in the cross section of the liquid crystal layer LQ, and the liquid crystal molecules LM become symmetric in the vicinity of the first alignment film AL1 and in the vicinity of the second alignment film AL2, with respect to the middle part as the boundary (splay alignment). In the state in which the liquid crystal molecules LM are splay-aligned, optical compensation can be made by the liquid crystal molecules LM in the vicinity of the first alignment film AL1 and the liquid crystal molecules LM in the vicinity of the second alignment film AL2, even in a direction inclined to the normal direction of the substrate. Therefore, when the first alignment treatment direction PD1 and the second alignment treatment direction PD2 are parallel and identical to each other, light leakage is small in the case of black display, a high contrast ratio can be realized, and the display quality can be improved.

In the meantime, when the first alignment treatment direction PD1 and the second alignment treatment direction PD2 are parallel and opposite to each other, the liquid crystal molecules LM are aligned with substantially equal pre-tilt angles, in the cross section of the liquid crystal layer LQ, in the vicinity of the first alignment film AL1, in the vicinity of the second alignment film AL2, and in the middle part of the liquid crystal layer LQ (homogeneous alignment).

Part of light from the backlight 4 passes through the first polarizer PL1 and enters the liquid crystal display panel LPN. The polarization state of the light, which enters the liquid crystal display panel LPN, is linear polarization perpendicular to the first polarization axis AX1 of the first polarizer PL1. The polarization state of such linear polarization hardly varies when the light passes through the liquid crystal display panel LPN at the OFF time. Thus, the linearly polarized light, which has passed through the liquid crystal display panel LPN, is absorbed by the second polarizer PL2 that is in the positional relationship of crossed Nicols in relation to the first polarizer PL1 (black display).

On the other hand, in a state in which a voltage is applied to the liquid crystal layer LQ, that is, in a state (ON time) in which a potential difference is produced between the pixel electrode PE and common electrode CE, a lateral electric field (or an oblique electric field), which is substantially parallel to the substrates, is produced between the pixel electrode PE and the common electrode CE. The liquid crystal molecules LM are affected by the electric field, and the major axes thereof rotate within a plane which is parallel to the X-Y plane, as indicated by solid lines in the Figure.

In the example shown in FIG. 2, the liquid crystal molecule LM in a lower half part of the region between the pixel electrode PE and main common electrode CAL rotates clockwise relative to the second direction Y, and is aligned in a lower left direction in the Figure. The liquid crystal molecule LM in an upper half part of the region between the pixel electrode PE and main common electrode CAL rotates counterclockwise relative to the second direction Y, and is aligned in an upper left direction in the Figure. The liquid crystal molecule LM in a lower half part of the region between the pixel electrode PE and main common electrode CAR rotates counterclockwise relative to the second direction Y, and is aligned in a lower right direction in the Figure. The liquid crystal molecule LM in an upper half part of the region between the pixel electrode PE and main common electrode CAR rotates clockwise relative to the second direction Y, and is aligned in an upper right direction in the Figure.

As has been described above, in the state in which the electric field is produced between the pixel electrode PE and common electrode CE in each pixel PX, the liquid crystal molecules LM are aligned in a plurality of directions, with boundaries at positions overlapping the pixel electrode PE, and domains are formed in the respective alignment directions. Specifically, a plurality of domains are formed in one pixel PX.

At such ON time, linearly polarized light perpendicular to the first polarization axis AX1 of the first polarizer PL1 enters the liquid crystal display panel LPN, and the polarization state of the light varies depending on the alignment state of the liquid crystal molecules LM when the light passes through the liquid crystal layer LQ. At the ON time, at least part of the light emerging from the liquid crystal layer LQ passes through the second polarizer PL2 (white display).

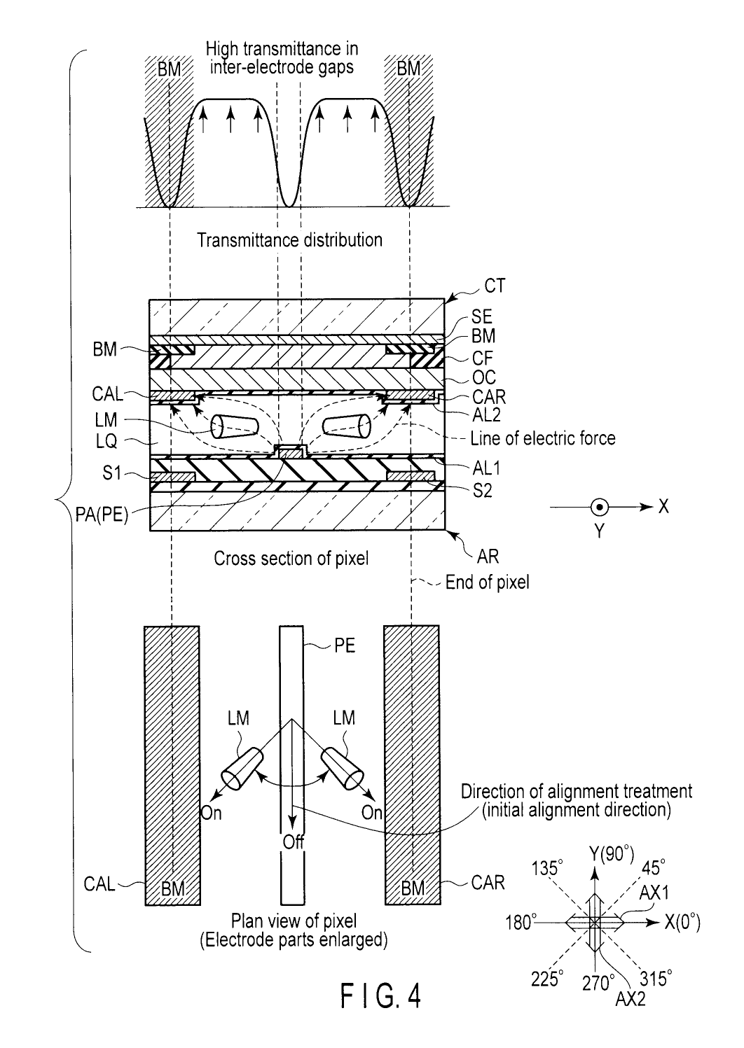

FIG. 4 is a view for explaining an electric field which is produced between the pixel electrode PE and common electrode CE in the liquid crystal display panel LPN shown in FIG. 2, and a relationship between directors of liquid crystal molecules LM by this electric field and a transmittance.

In the OFF state, the liquid crystal molecules LM are initially aligned in a direction which is substantially parallel to the second direction Y. In the ON state in which a potential difference is produced between the pixel electrode PE and the common electrode CE, when the director of the liquid crystal molecule LM (or the major-axis direction of the liquid crystal molecule LM) deviates by about 45° from the first polarization axis AX1 of the first polarizer PL1 and from the second polarization axis AX2 of the second polarizer PL2 in the X-Y plane, the optical modulation ratio of the liquid crystal layer LQ is highest (i.e. the transmittance at the aperture portion is highest).

In the example illustrated, in the ON state, the director of the liquid crystal molecule LM between the main common electrode CAL and the pixel electrode PE is substantially parallel to a 45°-225° azimuth direction in the X-Y plane, and the director of the liquid crystal molecule LM between the main common electrode CAR and the pixel electrode PE is substantially parallel to a 135°-315° azimuth direction in the X-Y plane, and a peak transmittance is obtained. Meanwhile, when the director of the liquid crystal molecule LM is substantially parallel to a 0°-180° azimuth direction in the X-Y plane or substantially parallel to a 90°-270° azimuth direction in the X-Y plane, the transmittance at the aperture portion becomes lowest.

In the ON state, the liquid crystal molecules LM over the pixel electrode PE and common electrode CE hardly rotate from the initial alignment direction. In other words, the directors of the liquid crystal molecules LM are substantially parallel to the 90°-270° azimuth direction. Thus, if attention is paid to the transmittance distribution per pixel, the transmittance is substantially zero over the pixel electrode PE and common electrode CE. On the other hand, a high transmittance can be obtained over almost the entire area of the inter-electrode gaps between the pixel electrode PE and the common electrode CE.

Each of the main common electrode CAL that is located immediately above the source line S1 and the main common electrode CAR that is located immediately above the source line S2 is opposed to the black matrix BM. Each of the main common electrode CAL and main common electrode CAR has a width which is equal to or less than the width of the black matrix BM in the first direction X, and does not extend toward the pixel electrode PE from the position overlapping the black matrix BM. Thus, the aperture portion in each pixel, which contributes to display, corresponds to regions between the pixel electrode PE and main common electrode CAL and between the pixel electrode PE and main common electrode CAR, these regions being included in the region between the black matrixes BM or the region between the source line S1 and source line S2.

According to the present embodiment, the counter-substrate CT includes the shield electrode SE on the inner surface 20A of the second insulative substrate 20. Thus, even if the outer surface of the counter-substrate is electrified, it is possible to shield an undesired electric field which may occur due to the charge on the electrified outer surface of the counter-substrate CT. Accordingly, even if the outer surface of the counter-substrate CT is electrified, the liquid crystal layer LQ is hardly affected by the undesired electric field, and a desired electric field, which is produced between the pixel electrode PE and common electrode CE, can be applied to the liquid crystal layer LQ.

In particular, in the region where the common electrode CE is not formed, that is, in the region where the aperture portion AP is formed, it becomes possible to suppress an alignment defect of liquid crystal molecules due to the operation of the liquid crystal molecules by the undesired electric field which is produced by the effect of electrification. Thereby, the degradation in display quality can be suppressed.

A liquid crystal display device having the structure shown in FIG. 3 was fabricated, and the surface of the second optical element OD2 was rubbed with cloth. Then, the effect of electrification was examined. It was found that no non-uniformity in display occurred due to the effect of electrification.

In addition, in recent years, there has been a demand for reduction in thickness of the liquid crystal display device, and there have been many cases in which the substrates are polished. In the case where the shield electrode SE is provided on the outer surface 20B of the second insulative substrate 20, such a disadvantage occurs that polishing cannot be performed or the shield electrode is removed in the process of polishing. On the other hand, the present embodiment adopts the structure in which the shield electrode SE is provided on the inner surface 20A of the second insulative substrate 20. Thereby, it is possible to suppress undesired electrification of the counter-substrate CT through fabrication steps before and after the polishing of the substrate.

Besides, electrical conduction of the shield electrode SE can easily be secured within the inside of the liquid crystal display panel LPN. Specifically, in the case where the shield electrode SE is provided on the outer surface 20B of the second insulative substrate 20, it is necessary to perform such a work as connecting a ground line to the shield electrode SE by soldering. However, when the shield electrode SE is provided on the inner surface 20A of the second insulative substrate 20, the shield electrode SE can be set at a ground potential, for example, by providing a ground line of a ground potential on the array substrate AR which is opposed to the shield electrode SE, and electrically connecting the ground line and the shield electrode SE via an electrically conductive member such as an electrically conductive spacer or silver paste.

Furthermore, in the structure in which the shield electrode SE is disposed over the entirety of the inner surface 20A of the second insulative substrate 20, no patterning of the shield electrode SE is needed, and thus the fabrication steps can be simplified and the manufacturing cost can be reduced.

Since the shield electrode SE has the relatively small film thickness T1, it is possible to suppress absorption of light passing through the aperture portion AP, while suppressing the entrance of an electric field from the outside, in the region overlapping the aperture portion AP. Although the shield electrode SE is formed of a substantially transparent, electrically conductive material, if the film thickness T1 increases, there is a tendency that the ratio of absorbed incident light increases. By decreasing the film thickness T1, the decrease in transmittance can be suppressed.

According to the present embodiment, a high transmittance can be obtained in the inter-electrode gap between the pixel electrode PE and the common electrode CE. Thus, a transmittance per pixel can sufficiently be increased by increasing the inter-electrode distance between the main pixel electrode and the main common electrode. As regards product specifications in which the pixel pitch is different, the peak condition of the transmittance distribution, as shown in FIG. 4, can be used by varying the inter-electrode distance (e.g. by varying the position of disposition of the main common electrode CA in relation to the pixel electrode PE that is disposed at a substantially central part of the pixel PX). Specifically, in the display mode of the present embodiment, products with various pixel pitches can be provided by setting the inter-electrode distance, without necessarily requiring fine electrode processing, as regards the product specifications from low-resolution product specifications with a relatively large pixel pitch to high-resolution product specifications with a relatively small pixel pitch. Therefore, requirements for high transmittance and high resolution can easily be realized.

According to the present embodiment, as shown in FIG. 4, if attention is paid to the transmission distribution in the region overlapping the black matrix BM, the transmittance is sufficiently lowered. The reason for this is that the electric field does not leak to the outside of the pixel from the position of the common electrode CE, and an undesired lateral electric field does not occur between pixels which neighbor each other with the black matrix BM interposed, and therefore the liquid crystal molecules in the region overlapping the black matrix BM keep the initial alignment state, like the case of the OFF time (or black display time). Accordingly, even when the colors of the color filters are different between neighboring pixels, the occurrence of color mixture can be suppressed, and the decrease in color reproducibility or the decrease in contrast ratio can be suppressed.

When misalignment occurs between the array substrate AR and the counter-substrate CT, there are cases in which a difference occurs in the inter-electrode distance between the pixel electrode PE and the common electrodes CE on both sides of the pixel electrode PE. However, since such misalignment commonly occurs in all pixels PX, the electric field distribution does not differ between the pixels PX, and the influence on the display of images is very small. In addition, even when misalignment occurs between the array substrate AR and the counter-substrate CT, leakage of an undesired electric field to the neighboring pixel can be suppressed. Thus, even when the colors of the color filters differ between neighboring pixels, the occurrence of color mixture can be suppressed, and the decrease in color reproducibility or the decrease in contrast ratio can be suppressed.

According to the present embodiment, the main common electrodes CA are opposed to the source lines S. In particular, when the main common electrode CAL and main common electrode CAR are disposed immediately above the source line S1 and source line S2, respectively, the aperture portion AP can be increased and the transmittance of the pixel PX can be improved, compared to the case in which the main common electrode CAL and main common electrode CAR are disposed on the pixel electrode PE side of the source line S1 and source line S2.

Furthermore, by disposing the main common electrode CAL and main common electrode CAR immediately above the source line S1 and source line S2, respectively, the inter-electrode distance between the pixel electrode PE, on one hand, and the main common electrode CAL and main common electrode CAR, on the other hand, can be increased, and a lateral electric field, which is closer to a horizontal lateral electric field, can be produced. Therefore, a wide viewing angle, which is the advantage of an IPS mode, etc. in the conventional structure, can be maintained.

According to the present embodiment, a plurality of domains can be formed in one pixel. Thus, the viewing angle can optically be compensated in plural directions, and a wide viewing angle can be realized.

The above-described example is directed to the case where the initial alignment direction of liquid crystal molecules LM is parallel to the second direction Y. However, the initial alignment direction of liquid crystal molecules LM may be an oblique direction D which obliquely crosses the second direction Y, as shown in FIG. 2. An angle θ1 formed between the second direction Y and the initial alignment direction D is 0° or more and 45° or less. From the standpoint of alignment control of liquid crystal molecules LM, it is very effective to set the angle θ1 at about 5° to 30°, more preferably, 20° or less. Specifically, it is desirable that the initial alignment direction of liquid crystal molecules LM be substantially parallel to a direction in a range of 0° to 20°, relative to the second direction Y.

The above-described example relates to the case in which the liquid crystal layer LQ is composed of a liquid crystal material having a positive (positive-type) dielectric constant anisotropy. Alternatively, the liquid crystal layer LQ may be composed of a liquid crystal material having a negative (negative-type) dielectric constant anisotropy. Although a detailed description is omitted, in the case of the negative-type liquid crystal material, since the positive/negative state of dielectric constant anisotropy is reversed, it is desirable that the above-described formed angle 01 be within the range of 45° to 90°, preferably the range of 70° or more and 90° or less.

Since a lateral electric field is hardly produced over the pixel electrode PE or common electrode CE even at the ON time (or an electric field enough to drive liquid crystal molecules LM is not produced), the liquid crystal molecules scarcely move from the initial alignment direction, like the case of the OFF time. Thus, even if the pixel electrode PE and common electrode CE are formed of a light-transmissive, electrically conductive material such as ITO, little backlight passes through these regions, and these regions hardly contribute to display at the ON time. Thus, the pixel electrode PE and common electrode CE do not necessarily need to be formed of a transparent material, and may be formed of an opaque wiring material such as aluminum, silver or copper.

Next, variations of the present embodiment are described.

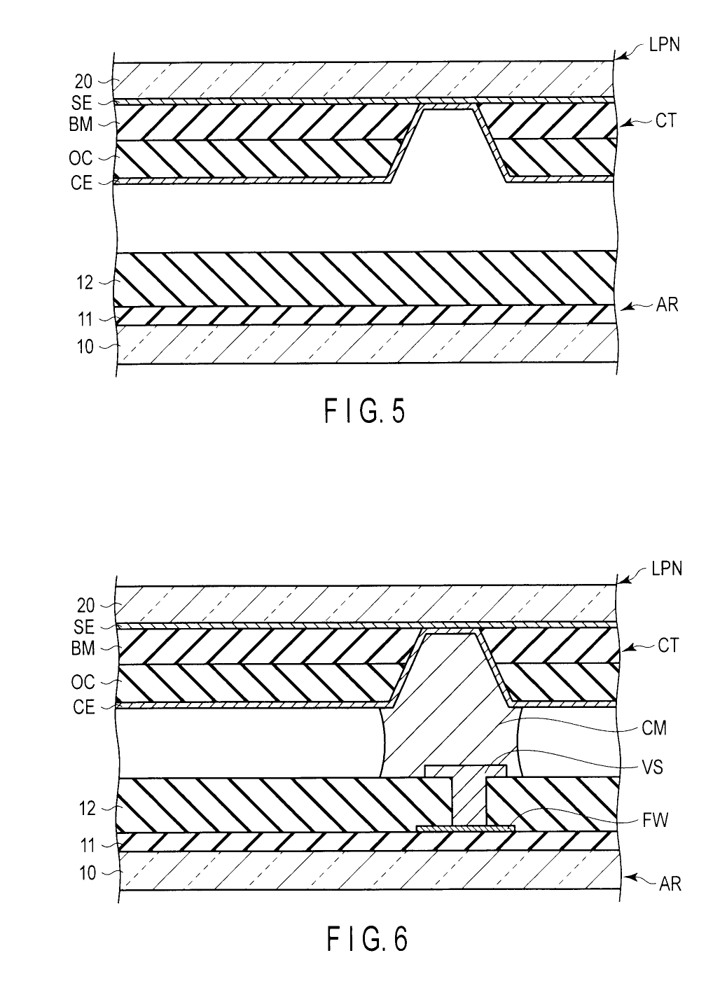

FIG. 5 is a cross-sectional view which schematically illustrates a structure for electrically connecting the shield electrode SE and the common electrode CE.

Specifically, the shield electrode SE may be set in a floating state, or may be set at a ground potential, as described above. In the example illustrated, the shield electrode CE is electrically connected to the common electrode CE including the main common electrode CA. The common electrode CE is electrically connected to the shield electrode SE via a contact hole, which is formed in the black matrix BM and the overcoat layer OC, on the outside of the active area, where the color filter is not disposed. The shield electrode SE is always set at the same potential (common potential) as the common electrode CE by electrically connecting the shield electrode SE and common electrode CE in this manner.

In this structure, compared to the case where the shield electrode SE is in the floating state, the shield electrode SE is always set at the same potential as the common electrode CE, and therefore a higher resistance to electrification can be obtained. The location of the electrical connection between the shield electrode SE and common electrode CE may be, as well as the region outside the active area, a region within the active area, an inner region surrounded by the sealant SB, or a region outside the sealant SB.

FIG. 6 is a cross-sectional view which schematically illustrates another structure for electrically connecting the shield electrode SE and the common electrode CE.

Specifically, the array substrate AR includes a power supply line FW to which a voltage that is to be applied to the common electrode CE is supplied. A power supply module VS of the array substrate AR is formed on the second interlayer insulation film 12 on the outside of the active area and is electrically connected to the power supply line FW. An electrically conductive member CM is disposed between the power supply module VS and the common electrode CE, and electrically connects both of them.

In addition, in the example illustrated, like the example illustrated in FIG. 5, the common electrode CE and the shield electrode SE are electrically connected. Further, the location at which the common electrode CE and shield electrode SE are electrically connected agrees with the location at which the common electrode CE and power supply module VS are electrically connected via the electrically conductive member CM. In the meantime, the location at which the common electrode CE and power supply module VS are electrically connected may be an inner region surrounded by the sealant SB or a region outside the sealant SB.

In this structure, too, like the example shown in FIG. 5, the shield electrode SE is always set at the same potential as the common electrode CE, and therefore a higher resistance to electrification can be obtained.

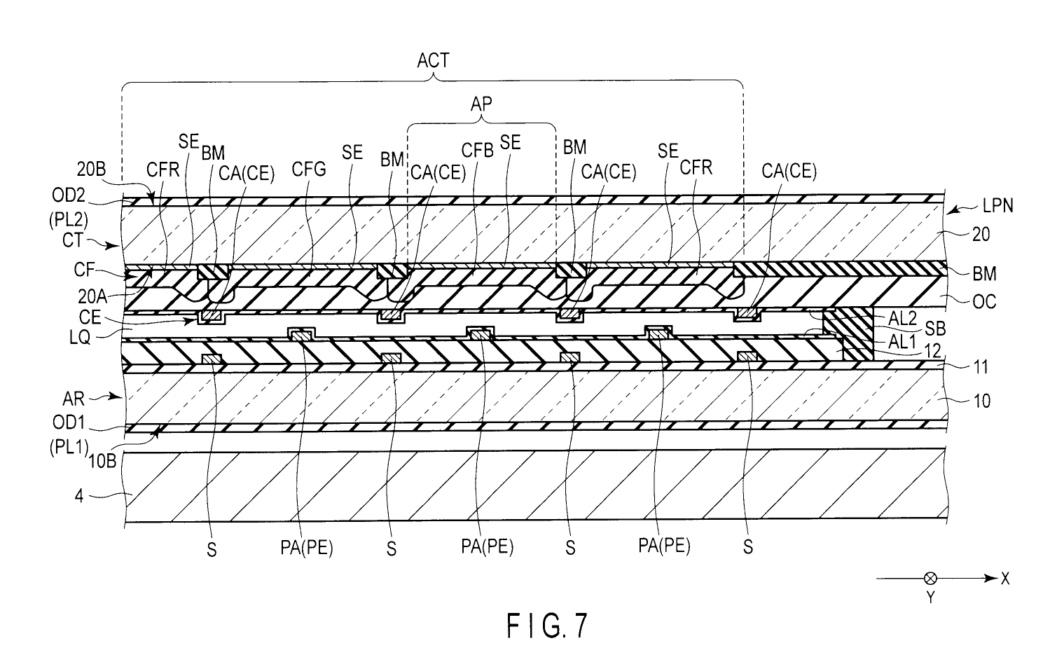

FIG. 7 is a schematic cross-sectional view, taken along line A-A in FIG. 2, showing another cross-sectional structure of the liquid crystal display panel LPN shown in FIG. 2. FIG. 7 shows only parts which are necessary for the description. The same structural parts as in the example illustrated in FIG. 3 are denoted by like reference numerals, and a detailed description thereof is omitted.

The structure shown in FIG. 7 differs from the structure shown in FIG. 3 in that the black matrix BM is disposed on the inner surface 20A of the second insulative substrate 20 in a manner to form the aperture portion AP, and that the shield electrode SE is disposed on that part of the inner surface 20A of the second insulative substrate 20, which is located in the aperture portion AP.

This shield electrode SE can be formed, for example, by forming a transparent, electrically conductive material over the entirety of the inner surface 20A of the second insulative substrate 20, and then patterning the transparent, electrically conductive material through a photolithography process. The cross-sectional structure as illustrated in FIG. 7 can be obtained by first performing either a process of forming the shield electrode SE or a process of forming the black matrix BM.

The color filter CF covering the shield electrode SE and extending over the black matrix BM, and the overcoat layer OC covering the color filter CF, are disposed as dielectric layers between the black matrix BM and shield electrode SE, on the one hand, and the main common electrode CA, on the other hand.

According to this structure, the black matrix BM and shield electrode SE hardly overlap. Thus, although a stepped portion corresponding to the film thickness of the black matrix BM is formed between the black matrix BM and shield electrode SE in the example illustrated in FIG. 3, such a stepped portion between the black matrix BM and shield electrode SE can be reduced in the example illustrated in FIG. 7. Therefore, in the aperture portion AP which substantially contributes to display, the thickness of the liquid crystal layer LQ can be made uniform, and the variance in retardation Δn·d (nn is refractive index anisotropy, and d is the thickness of liquid crystal layer LQ) of the liquid crystal layer LQ can be reduced. Thereby, it is possible to improve a drawback of display due to the variance in retardation Δn·d with respect to light passing through the aperture portion AP.

In addition, the structure illustrated in FIG. 7 differs from the structure illustrated in FIG. 3 in that the shield electrode is not disposed between the second insulative substrate 20 of the counter-substrate CT and the sealant SB, and the black matrix BM disposed on the inner surface 20A of the second insulative substrate 20 and the overcoat layer OC covering the black matrix BM are stacked between the second insulative substrate 20 of the counter-substrate CT and the sealant SB. Specifically, when a stress acts on the liquid crystal display panel LPN, a relatively large load acts on the part where the array substrate AR and the counter-substrate CT are attached by the sealant SB. Thus, since there is concern that the stacked member is peeled, it is desirable that the number of stacked members be small. In the structure shown in FIG. 7, the number of members interposed between the second insulative substrate 20 and the sealant SB is smaller than in the structure shown in FIG. 3, and also the number of interfaces between the members is smaller. Therefore, even if a large load acts on the part of the attachment by the sealant SB, peeling of the stacked members can be suppressed.

Since the shield electrode SE has electrical conductivity, it is desirable that the shield electrode SE be disposed at a position apart from the common electrode CE or the liquid crystal layer LQ, in order to prevent the shield electrode SE from affecting an electric field which is produced between the pixel electrode PE and the common electrode CE. As shown in FIG. 3 and FIG. 7, while the common electrode CE is formed on that side of the overcoat layer OC, which is opposed to the array substrate AR, the shield electrode SE is formed on the inner surface 20A of the second insulative substrate 20, and at least the color filter CF and the overcoat layer OC are interposed as dielectric layers between the common electrode CE and the shield electrode SE. This structure is also effective from the standpoint of spacing the shield electrode SE apart from the common electrode CE or the liquid crystal layer LQ.

In the meantime, the location of disposition of the shield electrode SE is not limited to the above-described example.

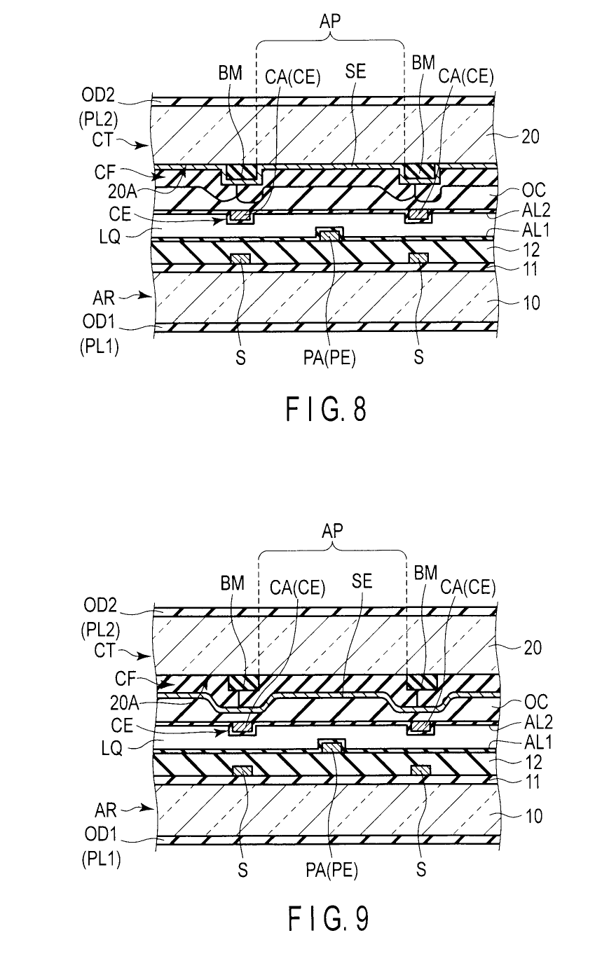

FIG. 8 is a schematic cross-sectional view, taken along line A-A in FIG. 2, showing another cross-sectional structure of the liquid crystal display panel LPN shown in FIG. 2.

The structure shown in FIG. 8 differs from the structure shown in FIG. 3 in that the black matrix BM is disposed on the inner surface 20A of the second insulative substrate 20 in a manner to form the aperture portion AP, and that the shield electrode SE is disposed on that part of the inner surface 20A of the second insulative substrate 20, which is located in the aperture portion AP, and covers the black matrix BM. In the other respects, the structure shown in FIG. 8 is the same as the example shown in FIG. 3. With this structure, too, the same advantageous effects as in the example shown in FIG. 3 can be obtained.

FIG. 9 is a schematic cross-sectional view, taken along line A-A in FIG. 2, showing another cross-sectional structure of the liquid crystal display panel LPN shown in FIG. 2.

The structure shown in FIG. 9 differs from the structure shown in FIG. 3 in that the black matrix BM is disposed on the inner surface 20A of the second insulative substrate 20 in a manner to form the aperture portion AP, that color filter CF is disposed on that part of the inner surface 20A of the second insulative substrate 20, which is located in the aperture portion AP, and extends over the black matrix BM, and that the shield electrode SE covers the color filter CF. In the other respects, the structure shown in FIG. 9 is the same as the example shown in FIG. 3. With this structure, too, the same advantageous effects as in the example shown in FIG. 3 can be obtained.

In the present embodiment, the structure of the pixel PX is not limited to the example shown in FIG. 2.

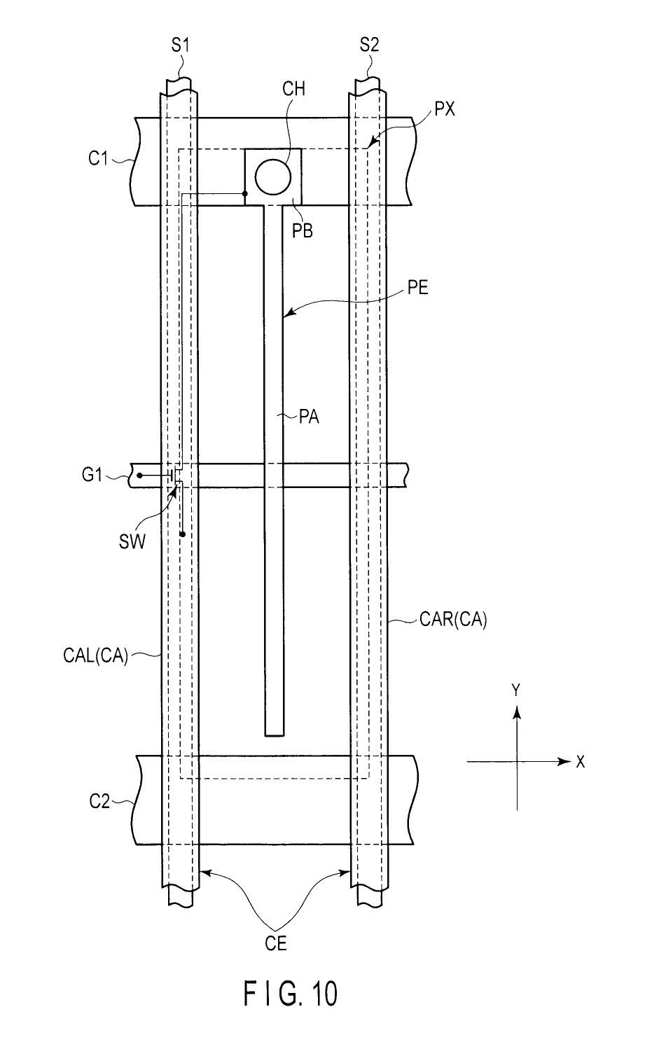

FIG. 10 is a plan view which schematically shows another structure example of the pixel PX at a time when the liquid crystal display panel LPN shown in FIG. 1 is viewed from the counter-substrate side.

This structure example differs from the structure example shown in FIG. 2 in that a storage capacitance line C1 is disposed at an upper side end portion of the pixel PX, a storage capacitance line C2 is disposed at a lower side end portion of the pixel PX, and a gate line G1 is disposed at a substantially central portion of the pixel PX.

Specifically, the gate line G1, storage capacitance line C1 and storage capacitance line C2 extend in the first direction X. The source line S1 and source line S2 extend in the second direction Y. This structure example is similar to the structure example shown in FIG. 2 in that the source line S1 is disposed at a left side end portion of the pixel PX, that the source line S2 is disposed at a right side end portion of the pixel PX, and that the switching element SW is electrically connected to the gate line G1 and source line S1 and is formed in the region overlapping the source line S1 and storage capacitance line C1.

The pixel electrode PE includes a sub-pixel electrode PB which overlaps the storage capacitance line C1 at the upper side end portion of the pixel PX, and a main pixel electrode PA which extends from the sub-pixel electrode PB in the second direction Y towards the lower side end portion of the pixel PX. The pixel electrode PE is electrically connected to the switching element SW via a contact hole in the sub-pixel electrode PB.

Like the structure example shown in FIG. 2, the common electrode CE is disposed on both sides of the pixel electrode PE in the X-Y plane.

In this structure example, too, the same advantageous effects as in the structure example shown in FIG. 2 can be obtained.

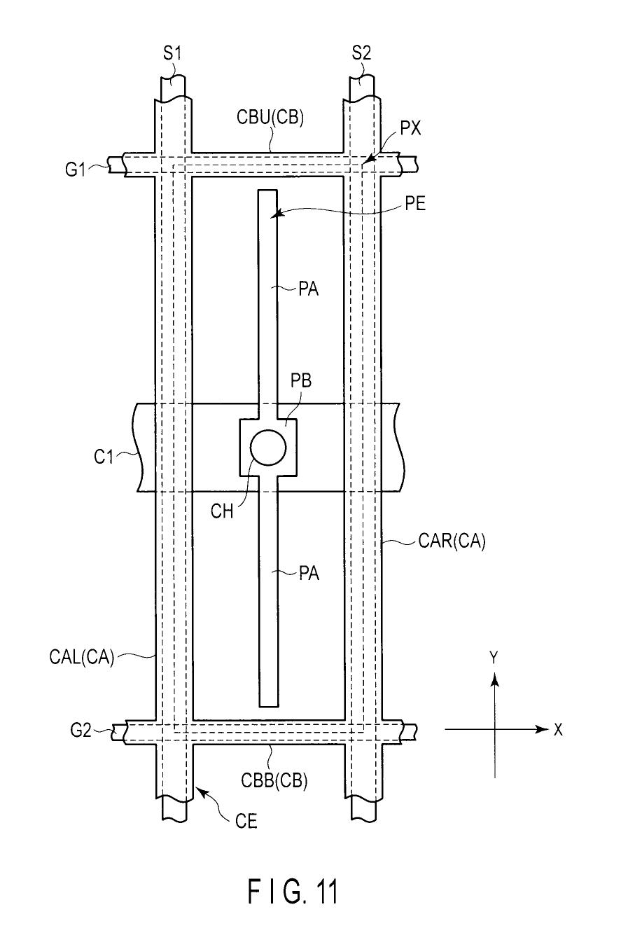

FIG. 11 is a plan view which schematically shows another structure example of the pixel PX at a time when the liquid crystal display panel LPN shown in FIG. 1 is viewed from the counter-substrate side.

This structure example differs from the structure example shown in FIG. 2 in that the common electrode CE is formed in a grid shape in a manner to surround the pixel PX.

Specifically, the common electrode CE includes, in addition to the above-described main common electrodes CA, sub-common electrodes CB extending in the first direction X. The main common electrodes CA and sub-common electrodes CB are formed integral or continuous with each other, and are provided on the counter-substrate CT.

The sub-common electrodes CB are located above the gate lines G. In the example illustrated, two sub-common electrodes CB are arranged in parallel, with a distance in the second direction Y. In the description below, in order to distinguish these sub-common electrodes CB, the sub-common electrode on the upper side in FIG. 11 is referred to as “CBU”, and the sub-common electrode on the lower side in FIG. 11 is referred to as “CBB”. The sub-common electrode CBU is disposed at the upper side end portion of the pixel PX, and is opposed to the gate line G1. Specifically, the sub-common electrode CBU is disposed to extend over a boundary between the pixel PX and a pixel neighboring on the upper side. The sub-common electrode CBB is disposed at the lower side end portion of the pixel PX, and is opposed to the gate line G2. Specifically, the sub-common electrode CBB is disposed to extend over a boundary between the pixel PX and a pixel neighboring on the lower side.

In this structure example, too, the same advantageous effects as in the structure example shown in FIG. 2 can be obtained.

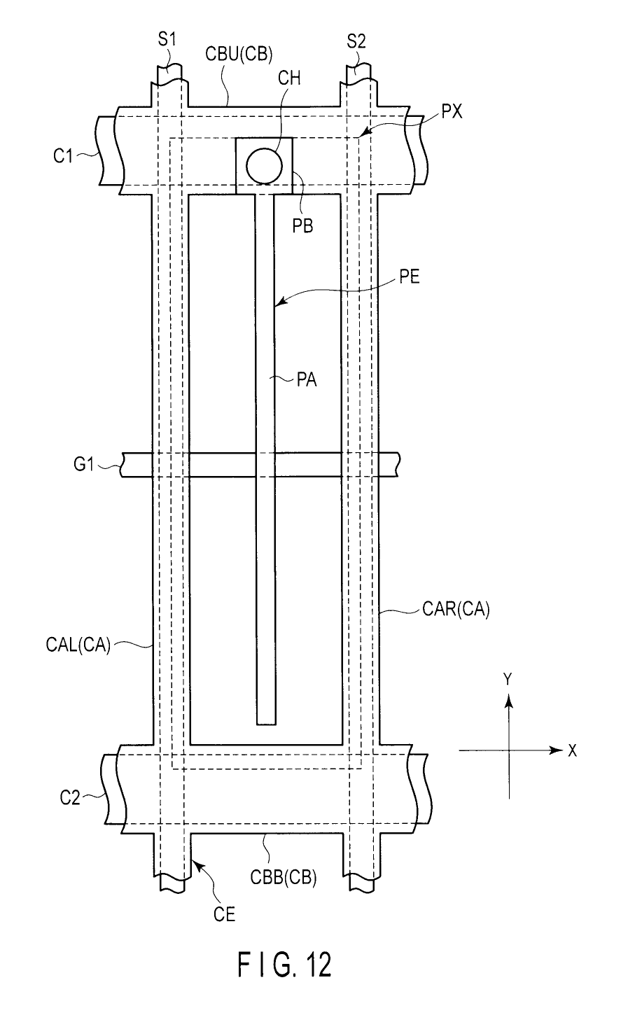

FIG. 12 is a plan view which schematically shows another structure example of the pixel PX at a time when the liquid crystal display panel LPN shown in FIG. 1 is viewed from the counter-substrate side.

This structure example differs from the structure example shown in FIG. 10 in that the common electrode CE is formed in a grid shape in a manner to surround the pixel PX.

Specifically, the common electrode CE includes, in addition to the above-described main common electrodes CA, sub-common electrodes CB extending in the first direction X. The main common electrodes CA and sub-common electrodes CB are formed integral or continuous with each other. The sub-common electrodes CB are located above the respective storage capacitance lines C. The sub-common electrode CBU, which is disposed at the upper side end portion of the pixel PX, is opposed to the storage capacitance line C1. In addition, the sub-common electrode CBB, which is disposed at the lower side end portion of the pixel PX, is opposed to the storage capacitance line C2.

In this structure example, too, the same advantageous effects as in the structure example shown in FIG. 2 can be obtained.

In the meantime, in the present embodiment, the common electrode CE may include, in addition to the main common electrodes CA provided on the counter-substrate CT, second main common electrodes which are provided on the array substrate AR and are opposed to the main common electrodes CA (or opposed to the source lines S). The second main common electrodes extend substantially in parallel to the main common electrodes CA, and have the same potential as the main common electrodes CA. By providing such second main common electrodes, an undesired electric field from the source lines S can be shielded. Besides, the common electrode CE may include, in addition to the main common electrodes CA provided on the counter-substrate CT, second sub-common electrodes which are provided on the array substrate AR and are opposed to the gate lines G or storage capacitance lines C. The second sub-common electrodes extend in a direction crossing the main common electrodes CA, and have the same potential as the main common electrodes CA. By providing such second sub-common electrodes, an undesired electric field from the gate lines G or storage capacitance lines C can be shielded. According to the structure including such second main common electrodes or second sub-common electrodes, the degradation in display quality can further be suppressed.

In addition, in the present embodiment, the pixel electrode PE may be formed in a cross shape, by elongating in the first direction X the sub-pixel electrode PB that is provided at a substantially central portion of the main pixel electrode PA. Besides, the pixel electrode PE may be formed in a T shape, by elongating in the first direction X the sub-pixel electrode PB that is provided at one end of the main pixel electrode PA.

Furthermore, in the present embodiment, the pixel electrode PE may include a plurality of main pixel electrodes PA which are arranged substantially in parallel at intervals in the first direction X. In this case, the main pixel electrode CE is disposed between neighboring main pixel electrodes PA, and such a positional relationship is maintained that the main pixel electrodes PA and main common electrodes CA are alternately arranged in the first direction X.

As has been described above, according to the present embodiment, a liquid crystal display device which has a good display quality can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first substrate including a first source line and a second source line which are disposed with a distance in a first direction and extend in a second direction crossing the first direction, a pixel electrode located between the first source line and the second source line and including a strip-shaped main pixel electrode linearly extending in the second direction, and a first alignment film which covers the pixel electrode, is formed of a material exhibiting horizontal alignment properties and is subjected to alignment treatment in a first alignment treatment direction;
a second substrate including an insulative substrate, a shield electrode disposed over an entirety of an inner surface of the insulative substrate, which is opposed to the first substrate, a black matrix formed on that side of the shield electrode, which is opposed to the first substrate, and forming an aperture portion opposed to the pixel electrode, a color filter which covers the shield electrode in the aperture portion and extends over the black matrix, an overcoat layer covering the color filter, a common electrode formed on that side of the overcoat layer, which is opposed to the first substrate, and including main common electrodes extending in the second direction on both sides of the main pixel electrode, and a second alignment film which covers the common electrode, is formed of a material exhibiting horizontal alignment properties and is subjected to alignment treatment in a second alignment treatment direction which is parallel to the first alignment treatment direction; and
a liquid crystal layer including liquid crystal molecules held between the first substrate and the second substrate,
wherein a surface resistance of the shield electrode is higher than a surface resistance of the common electrode.

2. The liquid crystal display device of claim 1, wherein a film thickness of the shield electrode is less than a film thickness of the common electrode.

3. The liquid crystal display device of claim 2, wherein the main common electrodes are located under the black matrix and are located above the first source line and the second source line.

4. The liquid crystal display device of claim 3, wherein the shield electrode and the common electrode are electrically connected.

5. The liquid crystal display device of claim 4, further comprising a power supply module provided on the first substrate and configured to apply a voltage to the common electrode, and an electrically conductive member which electrically connects the power supply module and the common electrode.

6. The liquid crystal display device of claim 1, wherein in a state in which an electric field is not produced between the pixel electrode and the common electrode, an initial alignment direction of the liquid crystal molecules is substantially parallel to the second direction, and the liquid crystal molecules are splay-aligned or homogeneously aligned between the first substrate and the second substrate.

7. The liquid crystal display device of claim 6, further comprising a first polarizer which is disposed on an outer surface of the first substrate and includes a first polarization axis, and a second polarizer which is disposed on an outer surface of the second substrate and includes a second polarization axis having a positional relationship of crossed Nicols with the first polarization axis, the first polarization axis of the first polarizer being perpendicular or parallel to the initial alignment direction of the liquid crystal molecules.

8. A liquid crystal display device comprising:
a first substrate including a first source line and a second source line which are disposed with a distance in a first direction and extend in a second direction crossing the first direction, a pixel electrode located between the first source line and the second source line and including a strip-shaped main pixel electrode linearly extending in the second direction, and a first alignment film which covers the pixel electrode, is formed of a material exhibiting horizontal alignment properties and is subjected to alignment treatment in a first alignment treatment direction;
a second substrate including an insulative substrate, a black matrix disposed on an inner surface of the insulative substrate, which is opposed to the first substrate, and forming an aperture portion opposed to the pixel electrode, a shield electrode disposed in that part of the inner surface of the insulative substrate, which is located in the aperture portion, a color filter which covers the shield electrode and extends over the black matrix, an overcoat layer covering the color filter, a common electrode formed on that side of the overcoat layer, which is opposed to the first substrate, and including main common electrodes extending in the second direction on both sides of the main pixel electrode, and a second alignment film which covers the common electrode, is formed of a material exhibiting horizontal alignment properties and is subjected to alignment treatment in a second alignment treatment direction which is parallel to the first alignment treatment direction; and
a liquid crystal layer including liquid crystal molecules held between the first substrate and the second substrate,
wherein a surface resistance of the shield electrode is higher than a surface resistance of the common electrode.

9. The liquid crystal display device of claim 8, further comprising a sealant which attaches the first substrate and the second substrate,
wherein a black matrix disposed on the inner surface of the insulative substrate and an overcoat layer covering the black matrix are disposed between the insulative substrate and the sealant.

10. The liquid crystal display device of claim 9, wherein a film thickness of the shield electrode is less than a film thickness of the common electrode.

11. The liquid crystal display device of claim 10, wherein the main common electrodes are located under the black matrix and are located above the first source line and the second source line.

12. The liquid crystal display device of claim 11, wherein the shield electrode and the common electrode are electrically connected.

13. The liquid crystal display device of claim 12, further comprising a power supply module provided on the first substrate and configured to apply a voltage to the common electrode, and an electrically conductive member which electrically connects the power supply module and the common electrode.

14. The liquid crystal display device of claim 8, wherein in a state in which an electric field is not produced between the pixel electrode and the common electrode, an initial alignment direction of the liquid crystal molecules is substantially parallel to the second direction, and the liquid crystal molecules are splay-aligned or homogeneously aligned between the first substrate and the second substrate.

15. The liquid crystal display device of claim 14, further comprising a first polarizer which is disposed on an outer surface of the first substrate and includes a first polarization axis, and a second polarizer which is disposed on an outer surface of the second substrate and includes a second polarization axis having a positional relationship of crossed Nicols with the first polarization axis, the first polarization axis of the first polarizer being perpendicular or parallel to the initial alignment direction of the liquid crystal molecules.

16. A liquid crystal display device comprising:
a first substrate including a first source line and a second source line which extend substantially in parallel to each other, and a pixel electrode including a main pixel electrode linearly extending between the first source line and the second source line;
a second substrate including an insulative substrate, a shield electrode disposed on an inner surface of the insulative substrate, which is opposed to the first substrate, and a common electrode including main common electrodes which are opposed to the first source line and the second source line, respectively, and extend substantially in parallel to the main pixel electrode; and
a liquid crystal layer including liquid crystal molecules held between the first substrate and the second substrate,
wherein a surface resistance of the shield electrode is higher than a surface resistance of the common electrode.

17. The liquid crystal display device of claim 16, wherein a film thickness of the shield electrode is less than a film thickness of the common electrode.

18. The liquid crystal display device of claim 16, wherein the second substrate further includes a black matrix, a color filter and an overcoat layer, and
the shield electrode is disposed over an entirety of an inner surface of the insulative substrate; the black matrix is formed on that side of the shield electrode, which is opposed to the first substrate, and forms an aperture portion opposed to the pixel electrode; the color filter covers the shield electrode in the aperture portion and extends over the black matrix; the overcoat layer covers the color filter; and
the common electrode is formed on that side of the overcoat layer, which is opposed to the first substrate.

19. The liquid crystal display device of claim 16, wherein the second substrate further includes a black matrix, a color filter and an overcoat layer, and
the black matrix is disposed on an inner surface of the insulative substrate and forms an aperture portion opposed to the pixel electrode; the shield electrode is disposed in the aperture portion; the color filter covers the shield electrode and extends over the black matrix; the overcoat layer covers the color filter; and the common electrode is formed on that side of the overcoat layer, which is opposed to the first substrate.

20. The liquid crystal display device of claim 16, further comprising a first polarizer which is disposed on an outer surface of the first substrate and includes a first polarization axis, and a second polarizer which is disposed on an outer surface of the second substrate and includes a second polarization axis having a positional relationship of crossed Nicols with the first polarization axis, and
wherein an initial alignment direction of the liquid crystal molecules in a state in which an electric field is not produced between the pixel electrode and the common electrode is substantially parallel to a direction of extension of the main pixel electrode, and is perpendicular or parallel to the first polarization axis.
